(19) United States
(12) Patent Application Publication
(10) Pub. No.: US 2008/0036326 A1
(43) Pub. Date: Feb. 14, 2008

(54) Rotary electric machine and magnet holder therefor

(75) Inventor: Kazuyuki Kito, Nagoya (JP)

Correspondence Address: OLIFF & BERRIDGE, PLC, P.O. BOX 320850, ALEXANDRIA, VA, 22320-4850, US

(73) Assignee: DENSO CORPORATION, KARIYA-SHI (JP)

(21) Appl. No.: 11/808,851

(22) Filed: Jun. 13, 2007

(30) Foreign Application Priority Data
Aug. 11, 2006 (JP) 2006-219714

(51) Int. Cl. H02K 1/18; H02K 1/17

(52) U.S. Cl. 310/154.14

(57) ABSTRACT

An electric rotary machine and a magnet holder for holding a main magnet pole on an inner periphery of a yoke of the electric rotary machine are disclosed. The magnet holder includes a dorsal base plate fixedly secured to the inner periphery of the yoke at equally spaced intervals in a circumferential direction of the yoke, a pair of sidewalls, formed on both sides of the dorsal base plate for admitting an interpole magnet to eliminate a leakage of magnetic fluxes of circumferentially neighboring two of main magnet poles, and held in pressured contact with sidewalls of the circumferentially neighboring two of the main magnet poles, and elastic segments extending from the pair of sidewalls in cantilever structures, respectively, for retaining the interpole magnet in a fixed place. Each elastic segment has a tapered shape to be less susceptible to vibration in excess from an engine.

### CROSS REFERENCE TO RELATED APPLICATIONS

This application is related to Japanese Patent Application No. 2006-219714, filed on Aug. 11, 2006, the content of which is hereby incorporated by reference.

### BACKGROUND OF THE INVENTION

1. Technical Field of the Invention

The present invention relates to magnetic field type electric rotary machines and, more particularly, to an electric rotary machine having magnet holders for fixing permanent magnets onto an inner periphery of a yoke.

2. Description of the Related Art

In the related art, attempts have heretofore been made to provide magnetic field type electric rotary machines each with a magnetic field employing permanent magnets. Each of the magnetic field type electric rotary machines has adopted high performance magnets with progressional development in minimization and lightweight. In addition, for the sake of achieving a high power with the same physical size, an electric rotary machine has been put to practical use with interpole magnets being used. Each of the interpole magnets has been disposed between circumferentially neighboring main magnet poles.

The main magnets poles may be fixedly secured onto the inner periphery of the yoke by adhesive bonding. However, adhesive bonding is disadvantageous from an environmental point (in recycling) of view.

To address such a disadvantage, U.S. Pat. No. 6,465,925 discloses an electric rotary machine employing a plurality of magnet holders, made of stainless steel, with which main magnet poles are fixedly fastened to an inner periphery of a yoke. Each of these magnet holders is disposed between circumferentially neighboring main magnet poles. Thus, the main magnet pole has both sides that are elastically retained with the magnet holders disposed on both sides of the main magnet pole. The magnet holder is formed in a substantially U-shape in cross section with an inside area accommodating the interpole magnet.

Meanwhile, the interpole magnet has an effect of minimizing a leakage of magnetic fluxes with a resultant increase in an output performance. In particular, the use of the interpole magnets provides an increase in output torque by a value of approximately 10%.

An electric rotary machine, especially, a starter, is subjected to different frictions depending on an on-vehicle engine and usage environment or the like. Therefore, in order to ensure favorable startability of the engine, a torque characteristic plays a role as an important item. Therefore, it is considered that setting the presence of or absence of the interpole magnets allows an increase and decrease in the torque characteristic. In such a case, for the sake of suppressing an increase in the number of component parts, it is advisable to employ magnet holders in common to the presence of or absence of the interpole magnets.

The magnet holder of the related art, disclosed in U.S. Pat. No. 6,465,925, is exemplarily shown as a development view in FIG. 8. As shown in FIG. 8, the magnet holder 100 has a dorsal base plate 102, a pair of side plates 104 circumferentially extending from both circumferential ends of the dorsal base plate 102, and four elastic segments 110 with each pair of elastic segments 110 axially extending from one side edge of each side plate 104. The four elastic segments 110 serve to hold an interpole magnet in an interspace defined between the side plates 104 extending from the dorsal base plate 102. Each of the elastic segments 110 takes the form of a cantilever structure, formed in an elongated plate-like configuration, which has a root portion 110a contiguous with the side plate 104 to be elastically deformable.

When placing the interpole magnet within the magnet holder 100, the elastic segments 110 retains the interpole magnet in the interspace defined between the side plates 104 in a fixed place in the manner as set forth above. However, with the electric rotary machine having no interpole magnet, the elastic segments 110 remain under free statuses. Under such statuses, if the elastic segments 110 are subjected to vibrations extremely in excess from the engine, the root portions 110a of the elastic segments 110 bear vibrational stresses. In the worst case, there is a fear of the elastic segments 100 being damaged at the root portions 110a.

### SUMMARY OF THE INVENTION

The present invention has been completed with a view to addressing the above issues and has an object to provide an electric rotary machine and a magnet holder for the electric rotary machine that can prevent elastic segments from damage regardless of the presence of or absence of interpole magnets.

To achieve the above object, a first aspect of the present invention provides a magnetic field type electric rotary machine comprising a yoke having an inner periphery carrying thereon a plurality of main magnet poles placed at equally spaced intervals in a circumferential direction of the yoke, and an armature rotatably supported in the main magnet poles of the yoke. A plurality of magnet holders are disposed on the inner periphery of the yoke at equally spaced intervals in the circumferential direction thereof for elastically supporting each of the main magnet poles on sidewalls thereof in the circumferential direction of the yoke. Each of the plurality of magnet holders comprises a dorsal base plate longitudinally extending along an axial direction of the yoke and fixedly secured to the inner periphery of the yoke, a pair of sidewalls, extending from the dorsal base plate on both sides thereof, which are held in pressured contact with sidewalls of circumferentially neighboring two of the main magnet poles and operative to accommodate each of interpole magnets in the presence of the same provided for eliminating a leakage of magnetic fluxes of the circumferentially neighboring two of the main magnet poles, and elastic segments extending from the pair of sidewalls in cantilever structures, respectively, for elastically retaining an inner peripheral wall of each of the interpole magnets. Each of the elastic segments has a root portion, serving as a fixed end of each of the cantilever structures, which extends from an axial end of each of the sidewalls, and a distal end portion axially extending from the root portion and serving as a free end of each of the cantilever structures, wherein each of the elastic segments has a tapered shape with the distal end portion having a narrower width than that of the root portion.

With such a structure, the magnet holder can be used in common to a motor having no interpole magnet and another motor adopting interpole magnets. That is, with the motor having no interpole magnet, each magnet holder is placed between the circumferentially neighboring main magnet poles to enable the magnet holders to elastically hold the main magnet pole on both sides thereof in the circumferential direction of the yoke. In addition, with the motor employing the interpole magnets, each of the interpole magnets is inserted to an interspace between the pair of side plates to enable the elastic segments to elastically hold an inner peripheral surface of each interpole magnet.

With the motor structured with no use of the interpole magnets, each of the elastic segments formed on the magnet holder remains in a free status and is subjected to vibrational stress coming from an engine. However, since the distal end portion of the elastic segment is made narrower in width than the root portion of the elastic segment, the distal end portion of the elastic segment has a less mass than that of the root portion. Therefore, even if the elastic segment is exerted with a vibrational stress from the engine at a rate extremely in excess, the vibrational stress being transferred to the root portion of the elastic segment is minimized. This allows the elastic segment to have an increased safety margin against an allowable stress, enabling the prevention of damage to the elastic segment.

With the electric rotary machine mentioned above, each of the elastic segments may further comprise a pair of bent segments, bent circumferentially inward from the pair of sidewalls at inner peripheral edges thereof, which have axial ends cut out to form four elastic segments, respectively.

With such a structure, when using the interpole magnets, the four elastic segments of the magnet holder can elastically support the interpole magnet on circumferential both sides on axial both ends thereof. This prevents the occurrence of the saccadic movement of the interpole magnet, enabling the interpole magnet to be retained in a further stable status.

With the electric rotary machine mentioned above, each of the elastic segments may preferably have a tapered shape that gradually decreases in width from the root portion to the distal end.

With the elastic segment formed in such a gradually tapered configuration, the distal end portion of the elastic segment has a less mass than that of the root portion of the elastic segment. Thus, even if the elastic segment is exerted with the vibrational stress from the engine at the rate extremely in excess, the vibrational stress being transferred to the root portion of the elastic segment is minimized. This enables the prevention of damage to the elastic segment.

With the electric rotary machine mentioned above, each of the elastic segments may preferably have a tapered shape that decreases stepwise in width from the root portion to the distal end portion.

With the elastic segment formed in such a stepwise tapered configuration, the distal end portion of the elastic segment has a less mass than that of the root portion of the elastic segment. Thus, even if the elastic segment is exerted with the vibrational stress from the engine at the rate extremely in excess, the vibrational stress being transferred to the root portion of the elastic segment is minimized. This enables the prevention of damage to the elastic segment.

With the electric rotary machine mentioned above, each of the elastic segments may preferably have the distal end portion formed with an engaging portion for supporting an axial end face of associated one of the interpole magnets.

With the elastic segments formed in such configurations, the engaging portions can restrict the axial movement of the interpole magnet. Therefore, even if the elastic segment has the narrowed distal end portion, the interpole magnet can be held in the magnet holder in a stabilized condition.

Another aspect of the present invention provides a magnet holder for fixedly holding each of main magnet poles disposed on an inner periphery of a yoke of an electric rotary machine. The magnet holder comprises a longitudinally extending dorsal base plate, a pair of sidewalls extending from the dorsal base plate on both sides thereof for supporting sidewalls of circumferentially neighboring two of the main magnet poles and operative to accommodate each of interpole magnets in the presence of the same provided for eliminating a leakage of magnetic fluxes of the circumferentially neighboring two of the main magnet poles and elastic segments extending from the pair of sidewalls in cantilever structures, respectively, for elastically retaining an inner peripheral wall of each of the interpole magnets. Each of the elastic segments has a root portion, serving as a fixed end of each of the cantilever structures, which extends from an axial end of each of the sidewalls, and a distal end portion axially extending from the root portion and serving as a free end of each of the cantilever structures, wherein each of the elastic segments has a tapered shape with the distal end portion having a narrower width than that of the root portion.

With such a structure, the magnet holder can be commonly used to a motor of the type having no interpole magnet and a motor of another type adopting interpole magnets. In a case where no interpole magnet is used in the motor, each magnet holder is placed between the circumferentially neighboring main magnet poles to enable the magnet holders to elastically hold the main magnet pole on both sides thereof in the circumferential direction of the yoke. In addition, with the motor employing the interpole magnets, each of the interpole magnets is inserted to an interspace between the pair of side plates to enable the elastic segments to elastically hold an inner peripheral surface of each interpole magnet.

With the motor structured in the absence of the interpole magnets, each of the elastic segments formed on the magnet holder remains in a free status and is subjected to vibrational stress coming from an engine. However, since the distal end portion of the elastic segment is made narrower in width than the root portion of the elastic segment, the distal end portion of the elastic segment has a less mass than that of the root portion. Therefore, even if the elastic segment is exerted with a vibrational stress from the engine at a rate extremely in excess, the vibrational stress being transferred to the root portion of the elastic segment is minimized. This allows the elastic segment to have an increased safety margin against an allowable stress, enabling the prevention of damage to the elastic segment.

### BRIEF DESCRIPTION OF THE DRAWINGS

FIG. 1 is a development view showing a magnet holder of one embodiment according to the present invention for use in an electric rotary machine.

FIG. 2A is a cross sectional view of the magnet holder taken on line A-A of FIG. 2B.

FIG. 2B is a front view of the magnet holder as viewed in an axial direction of a yoke of the electric rotary machine.

FIG. 3 is a perspective view of the magnet holder of the present embodiment.

FIG. 4 is a cross sectional view showing the magnet holder of the present embodiment in an assembled status with an interpole magnet fixedly retained.

FIG. 5 is a front view showing a magnetic field structure of a motor employing the magnet holders of the present embodiment.

FIG. 6 is a cross sectional view in half of a starter employing the electric rotary machine incorporating the magnetic holder of the present embodiment.

FIG. 7 is a development view showing a magnet holder of another embodiment according to the present invention for use in the electric rotary machine.

FIG. 8 is a development view showing a magnet holder of the related art structure.

### DETAILED DESCRIPTION OF PREFERRED EMBODIMENTS

Now, an electric rotary machine and a magnet holder of an embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

### First Embodiment

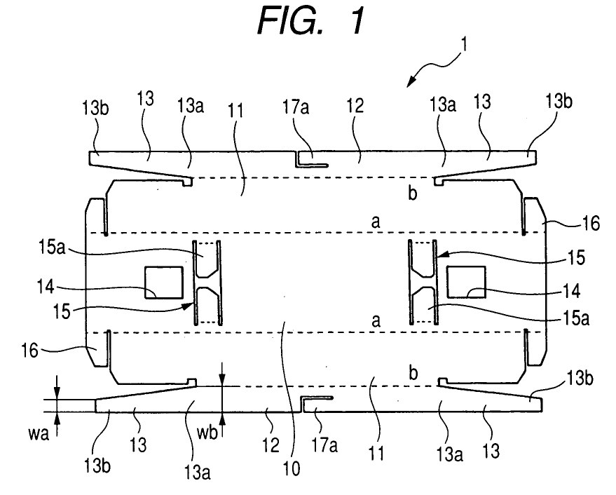

An electric rotary machine and a magnet holder of one embodiment according to the present invention is described below with reference to FIGS. 1 to 3.

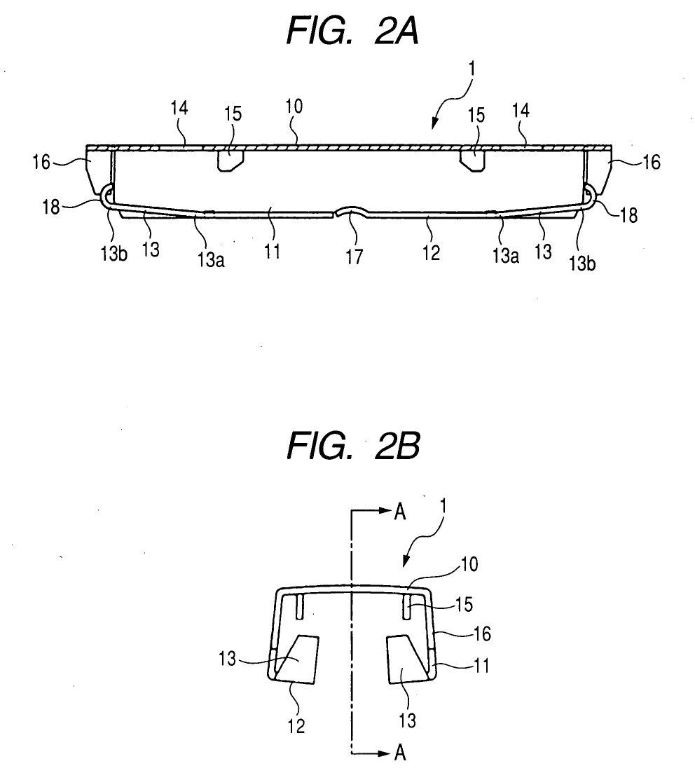

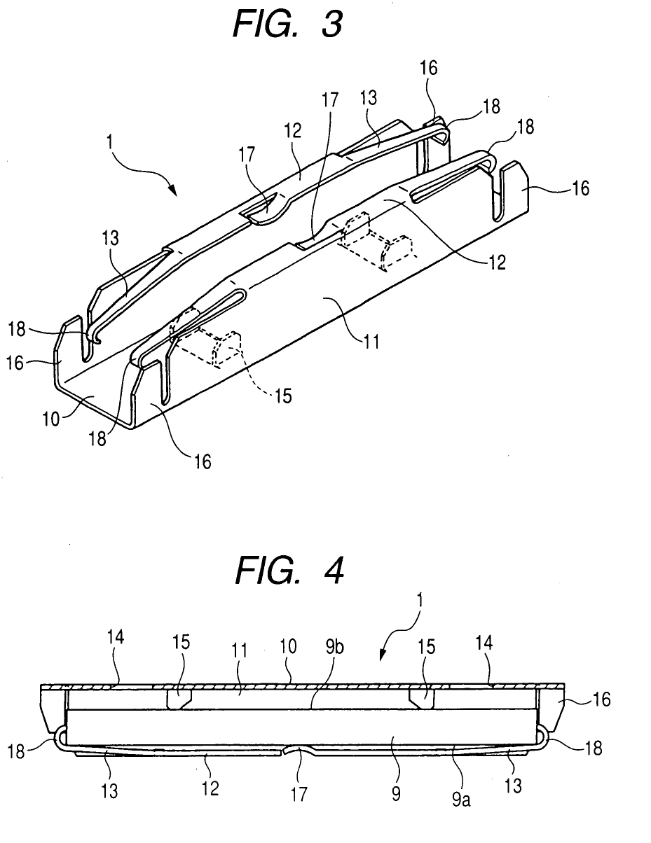

FIG. 1 is a development view of a magnet holder. FIG. 2A is a cross sectional view taken on line A-A of FIG. 2B and FIG. 2B is a front view as viewed in an axial direction. FIG. 3 is a perspective view of the magnet holder shown in FIG. 1.

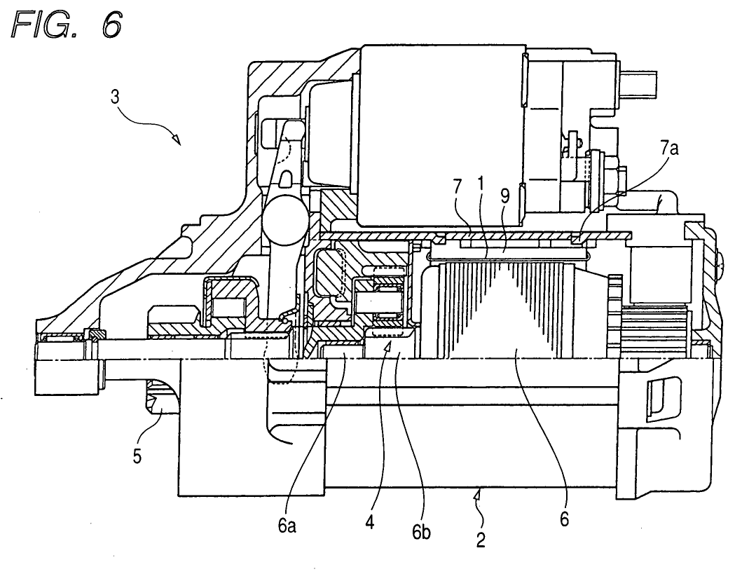

As shown in FIG. 6, the electric rotary machine of the present embodiment includes a magnetic field type DC motor 2 and is used as a major component part of a starter 3 for starling up an engine.

The motor 2 of the starter 3 includes an armature 6 having an armature shaft 6a, whose front end portion 6a carries thereon a gear 6b that forms a part of a speed reduction gear unit 4. The speed reduction gear unit 4 transfers an output torque of the motor 2 to a pinion gear 5 at a reduced speed with an amplified output. The pinion gear 5 is axially movable to an operative position in meshing engagement with a ring gear (not shown) of the engine. This allows the amplified torque to be transferred to the ring gear of the engine for startup thereof.

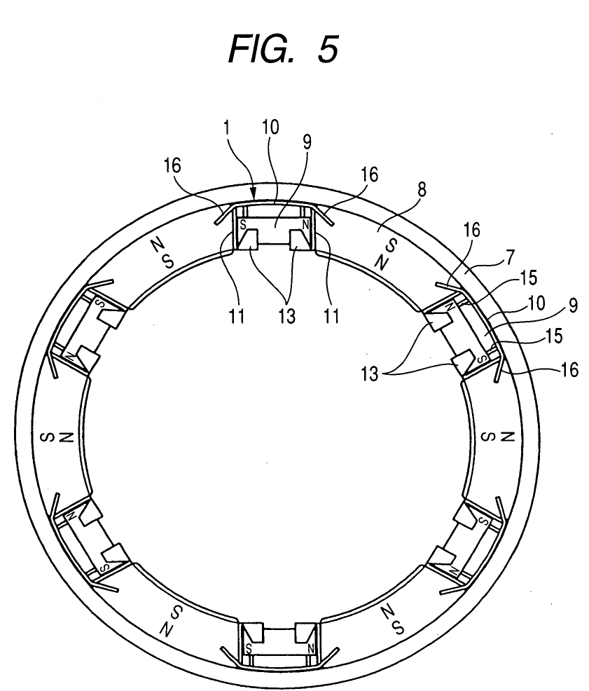

The motor 2 includes a magnetic field structure (see FIG. 5) for generating a magnetic field, and the armature 6 rotatably disposed on an inner circumferential periphery of the magnetic field.

As shown in FIG. 5, the magnetic field structure includes a cylindrical yoke 7 forming a magnetic circuit, a plurality of main magnet poles 8 fixedly supported on an inner circumferential periphery 7a of the cylindrical yoke 7 at equidistantly spaced intervals in a circumferential direction thereof by means of magnet holders 1 (see FIG. 3), and a plurality of interpole magnets 9 each disposed between circumferentially neighboring two of the main magnet poles 8.

The main magnet poles 8 are magnetized in S and N poles in a radial direction and fixedly mounted on the inner periphery 7a of the yoke 7 to provide N and S poles in alternating polarity along the circumferential direction of the yoke 7. In particular, one of the main magnet poles 8 has inner and outer peripheries magnetized in the S and N poles, respectively. Then, the other main magnet poles 8, placed circumferentially adjacent to the one main magnet pole 8, have inner and outer peripheries magnetized in the N and S poles in opposite polarity to the S and N poles of the one main magnet pole 8.

The interpole magnet 9 is magnetized in a circumferential direction so as to minimize a leakage of magnetic fluxes occurring between the circumferentially neighboring main magnet poles 8. To this end, each of the interpole magnets 9 has both circumferential ends magnetized in S and N poles, respectively, to be oriented in the circumferential direction of the yoke 7. The both circumferential ends of each interpole magnet 9 are circumferentially aligned in face with the adjacent inside poles of the circumferentially neighboring main magnet poles 8 and have the same polarities as those of the neighboring main magnet poles 8.

In fabricating the magnet holder 1, a stamping press is carried out on a blank stainless steel plate in a given profile to form the magnet holder 1 as shown in the development view of FIG. 1. Then, the magnet holder 1 is bent along bending lines indicated by broken lines “a”, “b” in FIG. 1 in a substantially U-shape in cross section.

The magnet holder 1 includes an axially elongated dorsal base plate 10, a pair of side plates 11 axially extending along longitudinal edges of the dorsal base plate 10 on both sides thereof, a pair of bent segments 12 axially extending along longitudinal edges of the side plates 11 on both sides thereof, respectively, and first and second pairs of elastic segments 13 with each pair of elastic segments 13 axially extending from both ends of each bent segment 12.

The dorsal base plate 10 is placed on the inner periphery 7a of the yoke 7 in an area between the circumferentially neighboring main magnet poles 8 and has a rectangular shape longer than an axial length of the associated interpole magnet 9. The dorsal base plate 10 is formed with a pair of axially spaced positioning holes 14 for the magnet holder 1 to be axially positioned on the inner periphery 7a of the yoke 7 and axially spaced retaining portions 15 formed in areas axially inside the positioning holes 14 for retaining an outer circumferential wall of the associated interpole magnet 9 such that the S and N poles of the interpole magnet 9 are circumferentially held in substantially face-to-face relation to the inside poles of the circumferentially neighboring main magnet poles 8.

Further, the dorsal base plate 10 has both axial ends formed with pairs of engaging claws 16, respectively. The engaging claws 16 serves to position the main magnet poles 8 in the axial direction of the yoke 7.

The positioning holes 14 are formed on the dorsal base plate 10 in both sides thereof at two longitudinally spaced positions (as viewed in a lateral direction in FIG. 1). The positioning holes 14 are fitted to embossed protrusions 7b, formed on the inner periphery 7a of the yoke 7 so as to radially extend inward, in engagement therewith to allow the magnet holder 1 to be axially positioned.

Turning back to FIG. 1, the retaining portions 15 are provided on the dorsal base plate 10 at longitudinally spaced positions in areas axially inside the positioning holes 14. Each of the retaining portions 15 includes a pair of circumferentially spaced cutout segments 15a formed by making cutouts on the dorsal base plate 10. The pair of cutout segment 15a is bent from the dorsal base plate 10 at right angles in parallel to the side plates 11 so as to extend in directions opposite to the yoke 7.

The pair of side plates 11 is bent along the bending lines “a”, respectively, at an angle little less than 90 degrees with respect to the dorsal base plate 10 such that the pair of cutout segments 15a is slightly opened toward the outside as shown in FIG. 2B.

The pair of bent segments 12 is bent inward along the bending lines “b” at angles of approximately 90 degrees with respect to the side plates 1. The pair of bent segments 12 has substantially central areas in a longitudinal direction formed with convexed portions 17, respectively. As shown in FIG. 1, the convexed portions 17 include cutout segments 17a formed by making “L”-shaped notches in partial areas of the bent segments 12, respectively, and inflecting the cutout segments 17a in circular arc shapes to cause circular arc ridges of the cutout segments 17a to protrude toward the dorsal base plate 10.

The four elastic segments 13 are formed on both sides of the pair of bent segments 12 upon cutting both end portions of the bent segments 12 in axial directions to be separate from the side plates 11, respectively. That is, each of the elastic segments 13 has a root portion 13a contiguous with the longitudinal end of each bent segment 12 and a distal end portion 13b axially extending outward from the root portion 13a and forming a free end in a cantilever structure.

As best shown in FIG. 2A, the elastic segments 13 are formed in sloped shapes such that the distal end portions 13b are closer to the dorsal base plate 10 than the root portions 13a. That is, the elastic segment 13 is formed to extend in an inclined shape toward the dorsal base plate 10 to allow the distal end portion 13b to be closer thereto.

Further, each elastic segment 13 is formed with the root portion 13a having a width “wb” and the distal end portion 13b having a width “wa” smaller than that of the root portion 13a. One exemplified structure of each of the elastic segments 13 is shown in FIG. 1. With such an exemplified structure, each of the elastic segments 13 has a tapered shape with a width gradually decreasing from the root portion 13a toward the distal end portion 13b. In such a case, each elastic segment 13 is configured in shape such that the width “wa” of the distal end portion 13b is made to be approximately half the width “wb” of the root portion 13a.

Furthermore, the distal end portion 13b of each elastic segment 13 is bent in a circular arc shape to form an engaging portion 18 as shown in FIG. 2A.

Next, a method of fixing the main magnet poles 8 and the interpole magnets 9 through the use of the magnet holders 1 will be described below in detail.

First, the two of the elastic segments 13, formed on the magnet holder 1 on one axial end thereof, are slightly expanded in a direction away from the dorsal base plate 10. Then, the interpole magnet 9 is inserted to an inside of the magnet holder 1 from one end thereof in the axial direction.

With the interpole magnet 9 inserted to the inside of the magnet holder 1, the convexed portions 17 are held in pressured contact with an inner peripheral wall 9a of the interpole 9 to elastically hold an outer peripheral wall 9b thereof to be held in abutting engagement with the four retaining portions 15 standing from the dorsal base plate 10 as shown in FIG. 4.

In addition, four corners of the interpole magnet 9 are elastically retained with the four elastic segments 13 in pressured contact therewith, thereby preventing the occurrence of saccadic movement of the interpole magnet 9.

Moreover, the engaging portions 18, formed on the distal end portions 13b of the four elastic segments 13, respectively, support axial both end faces of the interpole magnet 9, thereby blocking the axial displacement of the interpole magnet 9 to be positioned in the axial direction.

Subsequently, with the interpole magnet 9 retained under an assembled state, the magnet holder 1 is inserted from an axial end of the yoke 7 to an interspace 20 between the circumferentially neighboring main magnet poles 8 placed on the inner periphery 7a of the yoke 7 at a given interval. Here, the pair of side plates 11, provided in the magnet holder 1, is bent at the angle little less than 90 degrees with respect to the dorsal base plate 10. That is, the side plates 11 extend from the dorsal base plate 10 under a slightly and outwardly opened state. Thus, with the magnet holder 1 inserted between the circumferentially neighboring main magnet poles 8, the side plates 11 of the magnet holder 1 are brought into abutting engagement (in pressured contact) with sidewalls of the main magnet poles 8. This causes the side plates 11 of the magnet holder 1 to be fixed between the circumferentially neighboring main magnet poles 8 due to reaction forces of the side plates 11.

Meanwhile, each of the main magnet poles 8 has circumferential both sides elastically retained with the magnet holders 1. This allows each main magnet pole 8 to be tightly fixed to the inner periphery 7a of the yoke 7. Moreover, the four engaging claws 16 are bent outward from the dorsal base plate 10 with respect to the side plates 11, respectively, to retain axial both ends of the circumferentially neighboring main magnet poles 8, thereby restricting the axial displacements of the circumferentially neighboring main magnet poles 8 relative to the yoke 7.

### Advantageous Effects of First Embodiment

The motor 2 of the present embodiment employs the interpole magnets 9 for eliminating the leakage of magnet fluxes from the yoke. Each of the interpole magnets 9 is fixedly retained with the magnet holder 1 for fixing the circumferentially neighboring main magnet poles 8. That is, the magnet holders 1 are fixedly supported on the inner periphery 7a of the yoke 7 each in the interspace 20 between the circumferentially neighboring main magnet poles 8. This allows the magnet holders 1 to elastically support each of the main magnet poles 8 on circumferentially facing sidewalls thereof.

In addition, the interpole magnet 9 is inserted to the inside of the magnet holder 1 to be elastically held. Moreover, the magnet holders 1 can be employed to a motor in which no interpole magnet is employed. That is, the magnet holders 1 can be used in common to a motor with the interpole magnets 9 being employed and another motor with no use of the interpole magnet 9.

With the motor in which no interpole magnet 9 is employed, the four elastic segments 13 remain in free states in the magnet holder 1. Under such a condition, since the distal end portion 13b of the elastic segment 13 has the width narrower than that of the root portion 13a and has a lower mass than that of the root portion 13a. Thus, even if the elastic segment 13 is subjected to vibration extremely in excess from the engine, the root portion 13a of the elastic segment 13 bears a minimized vibrational stress. Therefore, the elastic segment 13 has an increased safety margin against an allowable stress, thereby enabling the prevention of damage to the elastic segment 13.

### Second Embodiment

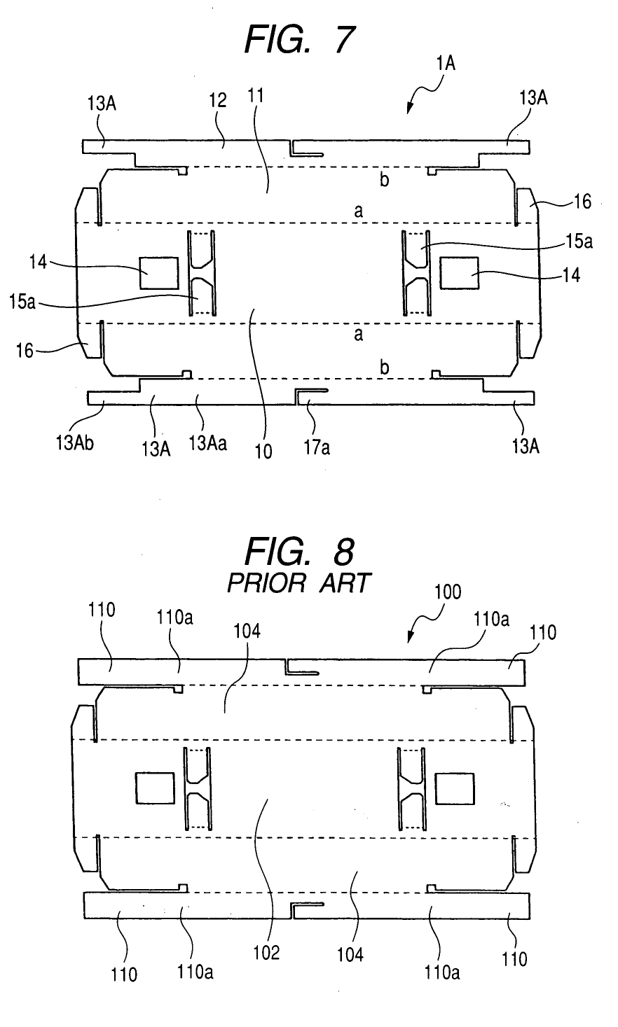

FIG. 7 is a development view showing a magnet holder 1A of a second embodiment according to the present invention.

The magnet holder 1A of the second embodiment differs from the magnet holder 1 of the first embodiment in respect of shapes of elastic segments 13A and will be described with a focus on differing features.

As shown in FIG. 7, with the magnet holder 1A of the present embodiment, each of the elastic segments 13A has a stepwise taper shape that varies stepwise in width from a root portion 13Aa toward a distal end portion 13Ab.

Even with the magnet holder 1A formed with such elastic segments 13A, the distal end portion 13Ab of each elastic segment 13A has less mass than that of the root portion 13Aa. Like the elastic segment 13 of the magnet holder 1 of the first embodiment, even if the elastic segment 13A is subjected to vibration extremely in excess from the engine, the vibrational stress, exerted to the root portion 13Ab of the elastic segment 13, is minimized, thereby preventing the elastic segment 13A from damage.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A magnetic field type electric rotary machine comprising:
a yoke having an inner periphery carrying thereon a plurality of main magnet poles placed at equally spaced intervals in a circumferential direction of the yoke; and
an armature rotatably supported in the main magnet poles of the yoke; and
a plurality of magnet holders disposed on the inner periphery of the yoke at equally spaced intervals in the circumferential direction thereof for elastically supporting each of the main magnet poles on sidewalls thereof in the circumferential direction of the yoke;
each of the plurality of magnet holders comprising:
a dorsal base plate longitudinally extending along an axial direction of the yoke and fixedly secured to the inner periphery of the yoke;
a pair of sidewalls, extending from the dorsal base plate on both sides thereof, which are held in pressured contact with sidewalls of circumferentially neighboring two of the main magnet poles and operative to accommodate each of interpole magnets in the presence of the same provided for eliminating a leakage of magnetic fluxes of the circumferentially neighboring two of the main magnet poles; and
elastic segments extending from the pair of sidewalls in cantilever structures, respectively, for elastically retaining an inner peripheral wall of each of the interpole magnets;
wherein each of the elastic segments has a root portion, serving as a fixed end of each of the cantilever structures, which extends from an axial end of each of the sidewalls, and a distal end portion axially extending from the root portion and serving as a free end of each of the cantilever structures, wherein each of the elastic segments has a tapered shape with the distal end portion having a narrower width than that of the root portion.

2. The magnetic field type electric rotary machine according to claim 1, wherein:
each of the elastic segments further comprises a pair of bent segments, bent circumferentially inward from the pair of sidewalls at inner peripheral edges thereof, which have axial ends cut out to form four elastic segments, respectively.

3. The magnetic field type electric rotary machine according to claim 1, wherein:
each of the elastic segments has a tapered shape that gradually decreases in width from the root portion to the distal end.

4. The magnetic field type electric rotary machine according to claim 1, wherein:
each of the elastic segments has a tapered shape that decreases stepwise in width from the root portion to the distal end portion.

5. The magnetic field type electric rotary machine according to claim 1, wherein:
each of the elastic segments has the distal end portion formed with an engaging portion for supporting an axial end face of associated one of the interpole magnets.

6. A magnet holder for fixedly holding each of main magnet poles disposed on an inner periphery of a yoke of an electric rotary machine, the magnet holder comprising:
a longitudinally extending dorsal base plate;
a pair of sidewalls extending from the dorsal base plate on both sides thereof for supporting sidewalls of circumferentially neighboring two of the main magnet poles and operative to accommodate each of interpole magnets in the presence of the same provided for eliminating a leakage of magnetic fluxes of the circumferentially neighboring two of the main magnet poles; and
elastic segments extending from the pair of sidewalls in cantilever structures, respectively, for elastically retaining an inner peripheral wall of each of the interpole magnets;
wherein each of the elastic segments has a root portion, serving as a fixed end of each of the cantilever structures, which extends from an axial end of each of the sidewalls, and a distal end portion axially extending from the root portion and serving as a free end of each of the cantilever structures, wherein each of the elastic segments has a tapered shape with the distal end portion having a narrower width than that of the root portion.

7. The magnetic field type electric rotary machine according to claim 6, wherein:
each of the elastic segments further comprises a pair of bent segments, bent circumferentially inward from the pair of sidewalls at inner peripheral edges thereof, which have axial ends cut out to form four elastic segments, respectively.

8. The magnetic field type electric rotary machine according to claim 6, wherein:
each of the elastic segments has a tapered shape that gradually decreases in width from the root portion to the distal end.

9. The magnetic field type electric rotary machine according to claim 6, wherein:
each of the elastic segments has a tapered shape that decreases stepwise in width from the root portion to the distal end portion.

10. The magnetic field type electric rotary machine according to claim 6, wherein:
each of the elastic segments has the distal end portion formed with an engaging portion for supporting an axial end face of associated one of the interpole magnets.
